(19) United States
(12) Patent Application Publication
(10) Pub. No.: US 2003/0089755 A1
(43) Pub. Date: May 15, 2003

(54) Device for breaking glass

(76) Inventors: Roy Peter Peers-Smith, Ross on Wye (GB); Anthony Graham Partington, Gloucestershire (GB); Martin Lawrance, Gloucestershire (GB)

Correspondence Address: MILBANK, TWEED, HADLEY & MCCLOY LLP, 1 CHASE MANHATTAN PLAZA, NEW YORK, NY, 10005-1413, US

(21) Appl. No.: 10/078,969

(22) Filed: Feb. 19, 2002

(30) Foreign Application Priority Data
Nov. 10, 2001 (GB) 0127083.4

(51) Int. Cl. B26F 3/00

(52) U.S. Cl. 225/103

(57) ABSTRACT

A glass window pane breaking device comprises a suction pad for attaching the device to the window, in use, a striker rod with a breaker tip, a trigger pawl engagable with the striker rod and a remotely operable trigger which is biased normally to prevent movement of the trigger pawl and thus to retain its engagement with the striker rod when this is held against the force of charged energy storage means urging the breaker tip in a direction to break the window pane, in use. A switch is also provided to ‘arm’ the device or place it in a ‘safe’ mode.

This invention relates to a device for breaking glass, and has particular application to a glass window pane breaking device for effecting entry into a vehicle or building containing, or suspected of containing, an Improvised Explosive Device (IED), or for facilitating the insertion of a tactical assault team into a building or similar structure.

During Explosive Ordnance Disposal/Improvised Explosive Device disposal (EOD/IEDD) operations—commonly referred to as ‘bomb disposal’ tasks—it is common for IEDs or other hazardous devices to be contained in vehicles and buildings. These vehicles and buildings are often locked. In these circumstances it is highly desirable to effect entry to the vehicle or building using remote means as the suspect device could detonate at any time. The preferred entry point is a glass window. However the present methods have a number of deficiencies. One approach to the problem is to use a robotic vehicle fitted with an explosive disrupter or other weapon to break the window. This approach is highly problematical as the physical access route to the vehicle or building may be obstructed. Additionally the use of explosives to effect entry may compromise the preservation of forensic evidence and lead to other unwelcome operational consequences. Another approach is for a bomb disposal operator to effect direct entry to the vehicle or building using a metal punch or similar hand-held tool to break the window. This places the operator at the target vehicle or building and exposes him/her to extreme personal risk throughout the duration of the task due to the possibility of detonation of the suspect device located within at the precise time that the positive action of breaking the window is effected.

During tactical assault tasks by military or law enforcement teams it is frequently necessary to gain access through windows. The preferred method is to use explosives but this can result in a loss of tactical surprise and jeopardise the success of the mission. Rigging the explosive charge in place can also take some minutes to complete. In addition the carriage and detonation of explosive charges raises personal safety concerns. In certain operational circumstances the window selected as a place of entry may also be rigged with an IED or booby-trap device.

It would be desirable if a glass window pane, on a vehicle or in a building containing, or suspected of containing, an IED, or the subject of a tactical assault, could be broken or shattered remotely without the use of explosives using a device that could be placed quickly and simply, and an object of the invention is to provide such a device.

According to the invention a device for breaking glass comprises an element attachable to the glass, in use, a striker having a tip for impacting said glass, energy storage means which are charged by movement of the striker to a first position thereof in which said tip is spaced from said glass and said charged energy storage means urge the striker to move to a second position thereof where said tip impacts said glass, in use, releasable locking means adapted to hold the striker in its first position, and actuation means operable to permit release of said locking means.

Preferably the device also comprises a mechanism for allowing or preventing operation of the actuation means. Desirably said mechanism is a switch operable between a first position where it prevents operation of the actuation means and a second position where it allows operation of the actuation means, and conveniently the switch is releasably held in each position by detent means. Advantageously the device has means for attaching it by a line to a frame or the like adjacent a glass pane so that when the tip impacts the glass pane the element is released therefrom and the device swings on said line to dislodge further glass of the pane.

The invention will now be described, by way of example, with reference to the accompanying drawings, in which:

FIG. 1 is a perspective view of a device for breaking glass panes according to one embodiment of the invention,

FIG. 2 is a view like FIG. 1, but with the device cocked and parts cut-away to show internal structure,

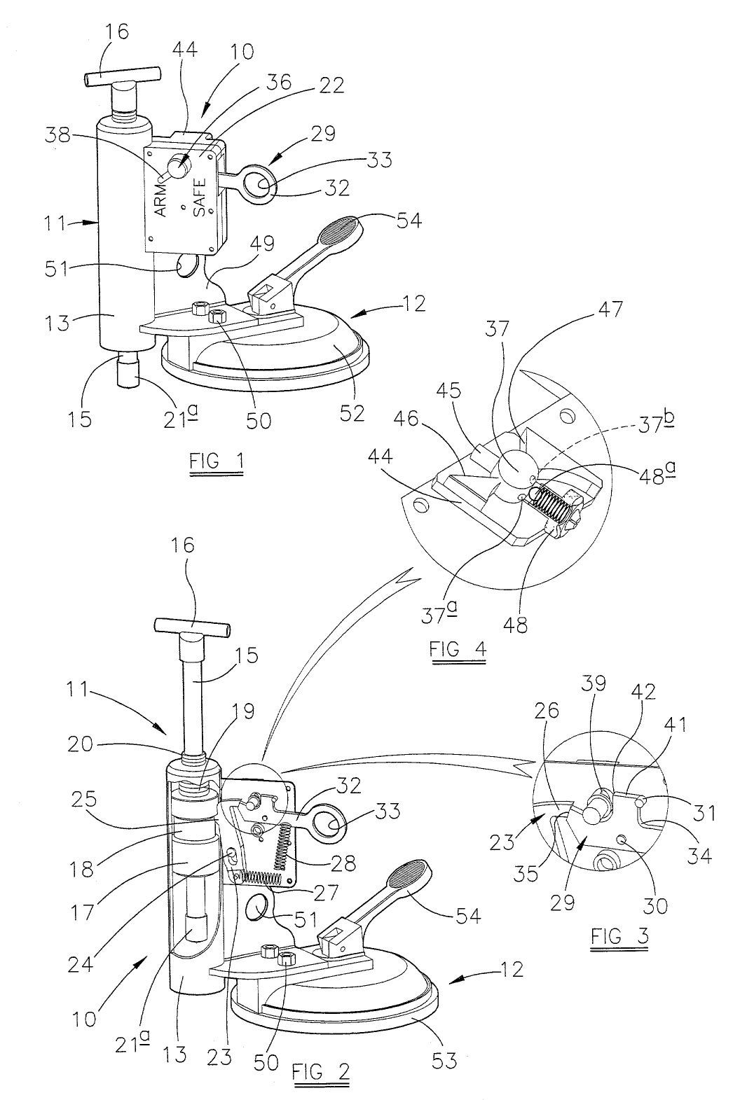

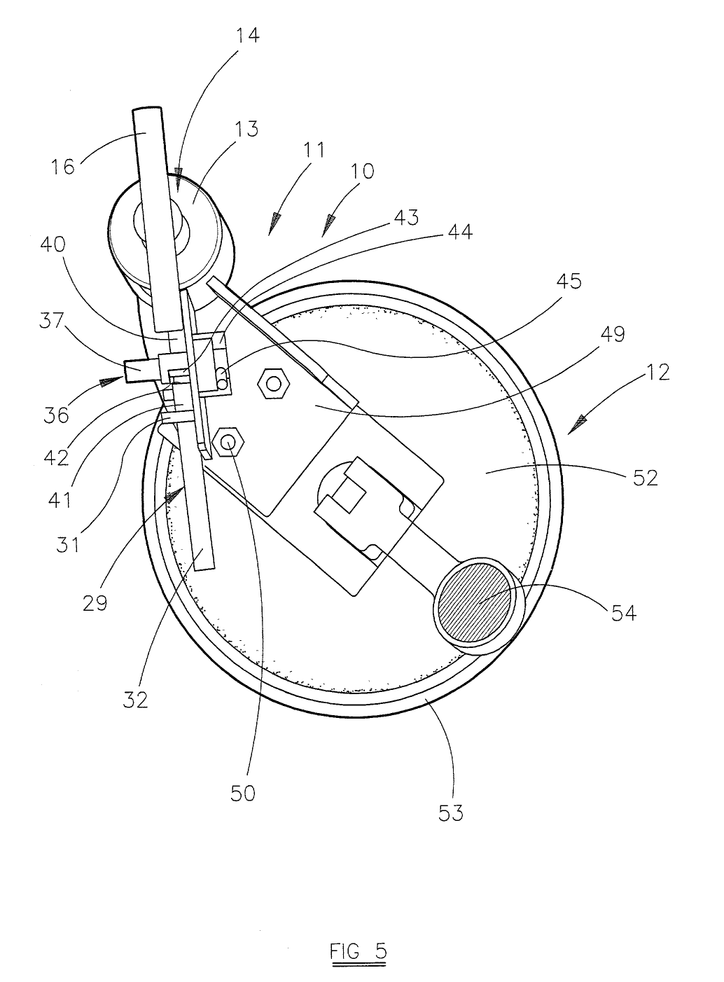

FIGS. 3 and 4 respectively show detailed views at the front and rear of the device as shown in FIG. 2, with FIG. 4 being part-sectional,

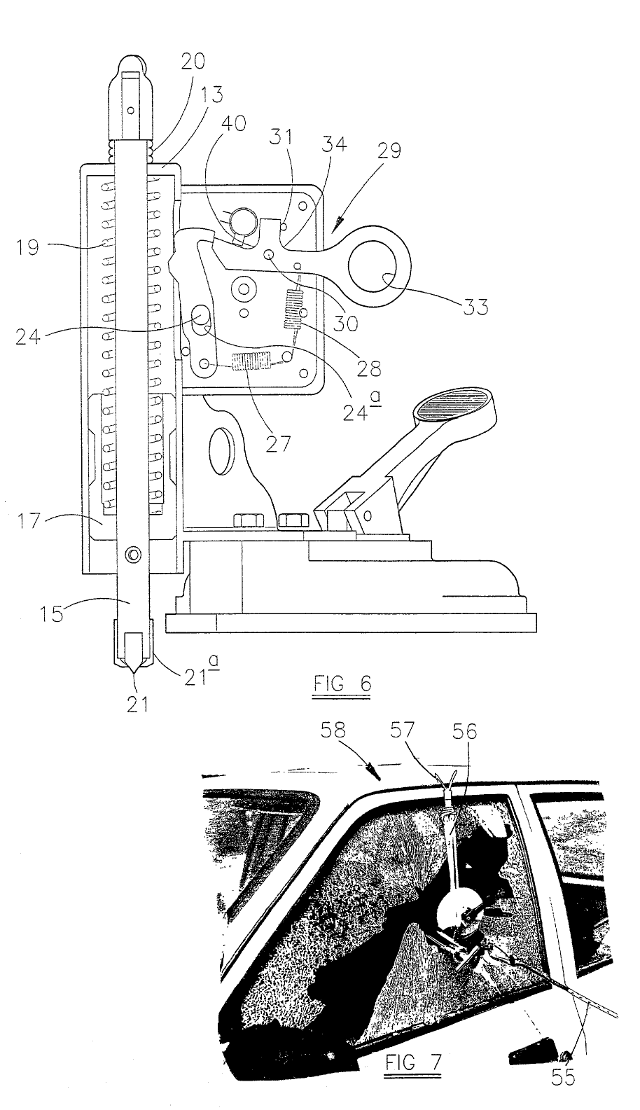

FIG. 5 is an enlarged top plan view of FIG. 2,

FIG. 6 is a schematic side view of the device in its fired state, showing various internal features, and

FIG. 7 is a pictorial perspective view of the device in use at a window of a motor vehicle, being shown shattering the glass thereof.

Although the present application relates generally to a device for breaking glass, it has particular application to a glass window pane breaking device as set out in the introductory paragraph of the specification. Accordingly, as will be described, the device, once in place, can be operated remotely by means of an attached line or similar actuation method in order to reduce the risk to an operator during EOD/IEDD tasks. It is also a feature of the device, according to one embodiment of the invention, that it can break or shatter a window without the use of explosives. Further the device can be put in place quickly and simply in order to reduce the period of time that an operator is exposed to serious risk during EOD/IEDD tasks (i.e. in the immediate vicinity of a suspected hazardous device) and to allow tactical assault tasks to proceed without undue delay. In a preferred embodiment, the device incorporates a positive safety control feature.

As will be described, it has been found that glass window panes of toughened glass can be broken or shattered effectively using ceramic material when it is propelled with sufficient force and, as will be described, a plunger tip of a device of the present invention is made of such material.

With the embodiment shown in the drawings, the glass window pane breaking device 10 comprises two sub-assemblies, namely a barrel sub-assembly 11 and a suction pad sub-assembly 12.

The barrel sub-assembly 11 comprises a hollow cylinder or barrel 13 preferably of stainless steel. Fitted in said barrel 13 for reciprocal movement along the central axis thereof is a stainless steel plunger rod 14, the rod having a shaft 15, at one end of which is a transverse operating handle 16, so that the end of the rod is of T-shape. The shaft 15 extends through a central circular opening in the closed end of the barrel 13 which is furthest from the suction pad sub-assembly 12. The opposite end of the barrel is preferably also closed, but provided with a central circular opening for movement therethrough of the end of the shaft remote from the handle 16. Alternatively this end could be open if the shaft is suitably guided within the barrel to retain it in a central position. As can be seen from FIG. 2, the shaft 15 between its opposite ends is enlarged by being connected to a circular section collar portion 17 which has its external surface as a close sliding fit with the interior surface of the barrel 13. An annular groove 18 is formed centrally of the collar portion 18 for a purpose to be described. Within the barrel, a coiled compression spring 19 is disposed around the shaft 15 with one of its ends bearing against an internal part of the collar portion 17 and its other end bearing against the closed inner end of the barrel remote from the sub-assembly 11. Around the shaft 15 outside of the barrel, between the barrel and the handle, is a freely disposed rubber buffer 20 for cushioning, particularly should the shaft 15 be propelled forward when the device is in a non-operative environment.

The rod 14 at its end remote from the handle 16 has a tip part 21 of ceramic material shaped to a conical point. This is retained by a cylindrical head 21a attached to the free end of the shaft by screw-thread means, for example by female threads on the inside of the cylindrical head being engaged with male threads at the free end of the plunger rod 14. By this arrangement, the tip 21 is thus replaceable, and desirably the ceramic cylindrical head which provides the tip or conical point at the forwardmost end of the plunger rod is made from aluminium oxide. However other suitable ceramic material could be used, it merely being required that the ceramic tip will puncture the surface tension of the (toughened) glass pane of the window or equivalent with which the device is used, in use. This results, as will be described, in the pane imploding across its entire area.

It will be appreciated that the spring 19 constitutes energy storage means which are charged when the handle 16 is pulled in a direction away from said closed end of the barrel mentioned above. As the spring 19 is compressed, it stores energy and tends to urge the plunger to move in the opposite direction to that in which it has been or is being pulled. As shown in FIG. 2, in its ‘cocked’ state, with the spring 19 fully compressed, the tip part 21 is received within the interior of the barrel.

To retain the plunger rod 14 in its cocked state, there is provided in a rectangular housing 22 fitted to or integral with the barrel at an open part of one side thereof, releasable locking means in the form of a retaining catch or trigger pawl 23, which is pivotally mounted at 24 to the housing 22. As can be seen from FIG. 2, the trigger pawl 23 is formed at one side thereof with a nose part 25, this being adjacent the end of the pawl which is nearest the closed end of the barrel 13 which has the spring 20 disposed thereat. This end of the pawl is formed with a finger 26 extending to the opposite side of the pawl from the nose part 25. The pivot 24 is between the nose part 25 and the opposite end of the pawl, and at said opposite end, i.e. the end of the pawl remote from the finger 26, the pawl is connected to one end of a tension spring 27 which biases the trigger pawl about its pivot. The side of the barrel at which the housing 22 is disposed is open, so that, as shown in FIG. 2, when the plunger rod 14 is in its cocked state the nose part 25 is biased by the spring 27 so that it extends into the groove 18. As can be seen from FIG. 2, both side surfaces of the nose part 25 are sloped, as are the respective opposite lead-in sides of the groove 18 so that even with the nose part being biased to protrude into the barrel by virtue of the force of the spring 27, respective inwards and outwards movement of the plunger rod is still possible. The other end of the spring 27 is fixed in the housing 22, and one end of a further tension spring 28 is also fixed in said housing, the other end of said further spring 28 being attached to a trigger 29 which is pivoted in the housing at 30. Also provided in the housing is a fixed cylindrical stop 31 for a purpose to be hereinafter described.

As shown best in FIG. 6, the pivot 24 for the pawl 23 is a cylindrical peg, which is fixed in the housing. This peg passes through an elongated slot 24a in the pawl, which slot has rounded ends. This arrangement allows the pawl to move up and down in the housing 22 about its pivot 24, with upwards movement, as will be described, being effected by the upwards movement of the plunger rod 14 when it is being cocked.

The trigger 29 has a release arm part 32 which extends out of the housing at the side thereof remote from the barrel and provides an eye 33. Within the housing, the junction between the main part of the trigger and the release arm part 32 is formed as a surface 34, an end of which is engaged by the stop 31 when the trigger is in its non-operative state as shown in FIG. 2. The trigger is held in this state by the force of the further tension spring 28 which has its other end connected to the release arm part 32 at the opposite side of said part 32 from the surface 34. As shown best in FIG. 3, the end of the trigger 29 which is innermost in the housing is formed as a flat abutment surface 35 which faces a flat end surface of the finger 26 of the trigger pawl, and in its non-operative state shown in FIGS. 2 and 3, it can be seen that this abutment surface 35 is in abutment with the flat end surface of the finger 26 so as to prevent the pawl 23 being pivoted in a clockwise direction, as viewed in FIG. 2, so that movement of the plunger rod 14 from its cocked position shown in FIG. 2 is prevented by the nose part 25 being retained in the groove 18. The pawl is thus wedged against the plunger rod by the trigger. It will be understood that actuation of the trigger from its non-operative to its operative state, i.e. its pivoting in an anti-clockwise direction as viewed in FIG. 2, is against the force of the further spring 28.

However such actuation of the trigger is either allowed or prevented by an arm/safety selector switch 36 in the form of an angularly moveable, stepped cylindrical shaft 37 partly contained in the housing. At the side of the housing shown in FIG. 1, it can be seen that the end of the cylindrical shaft 37 extending from the housing is formed with a knob having a short manually operable peg 38 for angularly moving the switch 36 between respective armed and safe positions which are indicated by wording on the ‘front’ face of the housing, as shown. Within the housing, as shown best in FIG. 3, it can be seen that the shaft 37 is stepped to form an increased diameter cylindrical portion 39 which is received in an area of the trigger which is cut-away to provide a surface 40, so that when the trigger is pivoted between its operative and non-operative states, and vice versa, this surface 40 moves adjacent the outer surface of part of the portion 39 of the shaft 37.

As shown in FIGS. 3 and 5, the surfaces 34 and 40 form the sides of a projecting part of the trigger. This part has a flat outer trigger surface 41, and the junction of this flat surface 41 with the arcuate surface 40 generally forms a corner or lobe 42. The arrangement of the increased diameter cylindrical portion 39 is such that its outer surface prevents pivoting of the trigger from its non-operative state shown in FIGS. 2 and 3 by virtue of this lobe 42 abutting against the surface of the portion 39 when the switch 36 is in its ‘safe’ position. However part of the outer surface of the portion 39 is cut-away over a certain length of arc, as best shown in FIG. 5, to form a recess 43 which is positioned adjacent the lobe 42 when the switch 36 is moved to its ‘arm’ position by manual angular movement of the peg 38. With the recess 43 now adjacent the lobe 42, it is possible for the trigger to be pivoted to its operative state, the lobe 42 moving into and being received in the recess 43 whilst such pivoting movement of the trigger takes place. The stop 31 engages the opposite end of surface 34 to limit such pivoting, which takes place against its spring 28.

As shown in FIG. 4, there is provided at the ‘rear’ surface of the housing a block 44 in which is received the opposite end of the shaft 37 which projects from the housing. A cover (not shown) over this block and associated parts forms a rear part of the housing. From this end of the shaft 37 there projects a stop peg 45 which effectively corresponds to the position of the peg 38, but can abut respective opposite flat stop surfaces 46,47 respectively formed by the block 44. By this means movement of the peg 38 is restricted to moving the shaft 37 to one or other of its correct extreme positions relating to the recess 43 being either in or out of alignment with the lobe 42. Preferably these two stop surfaces are spaced apart corresponding to angular movement of 90° of the shaft 37 and thus the peg 38. The exterior surface of the shaft 37 below the peg 45 is relieved at two spaced apart positions 37a, 37b respectively corresponding to the peg 45 engaging the surfaces 46,47 respectively to provide a detent lock for each of the armed and safe states of the switch 36. The detent locking is provided by an adjustable screw 48 threaded into the block 44 and having at its inner end a spring loaded ball 48a receivable in the two spaced apart reliefs or openings 37a, 37b in the outer surface of the end of the shaft 37 at said block 44. In this manner the switch 36 is positively held when in its selected armed or safe position, and this thus prevents any inadvertent or accidental movement of the peg 38 from one of these states to the other.

The barrel sub-assembly 11 is fitted with a L-shaped mounting bracket 49, preferably of stainless steel, which bracket is attached by means of retaining bolts 50 to the suction pad sub-assembly 12. The bracket 49 is provided with an eye 51 to allow attachment of a retaining line during operation, as will be described.

The suction pad sub-assembly 12 comprises a shallow cup-shaped main body 52, which is preferably manufactured from aluminium. This body contains a rubber suction pad 53. Suction is effected by pivoting through 90° from its vertical position, a central lever 54 at the rear of the body 52. This lever operates an internal spring mechanism (not shown) to draw a vacuum on the suction pad when it is placed on a smooth glass window pane. It will be understood that the precise construction and operation of the suction pad sub-assembly, or an equivalent anchor means for attaching the barrel sub-assembly 11 to the window pane to be broken, can be of any convenient form and could, for example, be a known proprietary item.

In use, the device can be cocked with the switch 36 in either of its two positions.

Movement of the plunger rod to compress its spring 19 firstly brings the collar portion 17 into contact with nose part 25 which cannot move out of the barrel. Continued such movement of the plunger rod however moves the pawl with it, so that there is relative movement between the slot 24a and pivot peg 24. As viewed in FIG. 6, the peg 24 is originally at the ‘upper’ end of the slot. As the pawl is moved by the collar portion, the fixed peg eventually reaches the ‘bottom’ of the slot 24a. In this state, the finger 26 is now clear of the trigger surface 35 so that further movement of the plunger rod 14 now forces the pawl out of the barrel, until the groove 18 reaches the nose part 25. The pawl then moves in the opposite direction to its previous movement to bring the fixed peg 24 to the ‘upper’ end of the slot, with the pawl pivoting to move its nose part in the groove 18, as shown in FIG. 2. Such pawl movement in said opposite direction again brings its finger into the wedging relationship with surface 35 so as again to prevent movement of the pawl nose part out of the barrel.

The switch 36 can then be moved to its arm or safe position. As previously mentioned, in its safe position inadvertent actuation of the device is prevented.

A line 55 for operation in use by an operator is attached to the eye 33, this line typically being in excess of 100 metres during EOD/IEDD tasks, but possibly being less during tactical assault tasks. Additionally a short line 56, preferably with a gripper 57 or the like attachment means at its free end is attached to the eye 51.

Operation of the device requires initial placement by an operator. This initial placement involves the operator attaching the suction pad sub-assembly 12 to the window pane to be broken, for example at the window of a vehicle 58, this being accomplished by pressing the sub-assembly 12 onto the window pane and operating the lever 54 as described to create the required suction. Additionally the short line 56 at the eye 51 is attached by its gripper 57, or in any other suitable manner, to the vehicle roof, i.e. at a gutter thereof. The operator then retires to a safe position to effect final initiation of the window breaking process.

As mentioned above, the operator is able to effect final initiation at a position remote from the suspect vehicle with operation of the breaker device then being effected by means of the line attached to the eye 33, with the operator having moved the switch 36 to the armed position at the time of securing the device to the vehicle window glass pane.

Accordingly with the device armed and in place, the operator pulls on the line which is arranged to pivot the trigger anti-clockwise as viewed in FIGS. 1 and 2, i.e. towards the rear of the barrel. This movement of the trigger arm allows the plunger rod 14 to move ‘forward’ so that its tip moves out of the barrel 13, as the collar portion 17 abutted by the spring 19 is now able to force the nose part 25 out of the barrel, given that, as stated, the trigger has pivoted so that its flat abutment surface 35 no longer blocks movement of the finger part 26 of the pawl 23. The pawl thus moves out of the barrel during passage of this collar portion 17 along the barrel, the pawl nose part 25 moving back into the barrel after such passage, by virtue of the force of its spring 27. As mentioned above, the cocking of the device stores energy in the spring 19 as it is compressed into the state shown in FIG. 2. Accordingly as soon as the pawl is free to pivot, the energy stored in the spring 19 forces the plunger rod 14 to move from its FIG. 2 to its FIG. 1 position, moving the pawl inwards, as described above, during this operation. The spring 19 can be arranged to be fully relaxed when it has moved the plunger rod to its FIG. 1 position, or alternatively it could still have a small amount of energy stored therein, in that state. The FIG. 1 position can be when the connection between the T-shaped operating handle 16 and the shaft 15 engages the buffer 20 as shown, or alternatively some other form of stop can be provided

As mentioned previously, the forward propulsion of the plunger rod causes the pointed head of the ceramic tip part 21 to impact the surface of the glass pane. The ceramic tip will puncture the surface tension of the glass pane, with the window then imploding across its entire area (FIG. 7). The connection of the device to the vehicle roof or gutter by virtue of the short line 56 connected to the eye 51, means that after the impact by the tip part 21, the reaction of the suction pad sub-assembly, which is effectively suspended from the vehicle roof, will now dislodge the remains of the shattered glass by swinging round, thereby leaving a large hole in the window. The use of the short line 56 at the eye 51 prevents the device dropping into the vehicle and onto any suspect package therein. With a large vehicle cab, the device could be damaged by dropping a considerable distance at the exterior of the vehicle onto a hard surface, and the use of the line at eye 51 prevents this occurring.

It is to be understood that the present invention may also be deployed by an EOD/IEDD remotely controlled vehicle or robot, whereby the said mounting bracket can be held by a manipulator fitted to the EOD/IEDD remotely controlled vehicle or robot. Final initiation can be achieved by means of a line, as at present, or a solenoid or similar switch connected to the EOD/IEDD remotely controlled vehicle or robot. It is also understood that the present invention may also have uses other than those detailed above, for example the venting of containers or enclosed spaces containing harmful or toxic gases.

1. A device for breaking glass comprises an element attachable to the glass, in use, a striker having a tip for impacting said glass, energy storage means which are charged by movement of the striker to a first position thereof in which said tip is spaced from said glass and said charged energy storage means urge the striker to move to a second position thereof where said tip impacts said glass, in use, releasable locking means adapted to hold the striker in its first position, and actuation means operable to permit release of said locking means.

2. A device as claimed in claim 1, wherein the striker is slidably movable in a barrel into which the locking means extends to hold the striker in its first position.

3. A device as claimed in claim 2, wherein the striker is a rod, around part of the length of which is carried a collar, having a groove into which part of said locking means extends to hold the striker in its first position.

4. A device as claimed in claim 3, wherein the energy storage means is a compression spring within the barrel, acting between said barrel and the collar.

5. A device as claimed in claim 4, wherein the compression spring has one end against a closed end of the barrel through which the rod extends.

6. A device as claimed in claim 5, wherein the other end of the compression spring bears against an internal end surface of the collar.

7. A device as claimed in claim 6, wherein the compression spring is coiled around the rod and has part thereof received within said collar.

8. A device as claimed in claim 5, wherein the end of the rod which extends through said closed end of the barrel is formed with an operating handle for moving the striker to its first position.

9. A device as claimed in claim 8, wherein a buffer is disposed around the rod at a position outside of the barrel, between said operating handle and said closed end of the barrel.

10. A device as claimed in claim 1, wherein the striker comprises a rod and said tip is releasably attached to an end thereof.

11. A device as claimed in claim 10, wherein said tip is attached to said rod by means of a head screw-threadedly engaged on said end of the rod.

12. A device as claimed in claim 1, wherein the tip is of ceramic material.

13. A device as claimed in claim 12, wherein the tip is of aluminium oxide.

14. A device as claimed in claim 3, wherein movement of said part of the locking means into or out of said groove is by way of said locking means pivoting about a fixed pivot.

15. A device as claimed in claim 14, wherein said pivot is received in a slot in said locking means, so that the locking means can be moved relative to said pivot by said striker when it is moved to its first position.

16. A device as claimed in claim 1, wherein the locking means is biased to a position where it is adapted to hold the striker when the striker is in its first position.

17. A device as claimed in claim 15, wherein the locking means is itself held in its position where it holds the striker in its first position, by engagement of part of the locking means by said actuation means.

18. A device as claimed in claim 15, wherein the actuation means is biased to a first position in which it engages part of the locking means except when said locking means is moved relative to said pivot by said striker, whereupon said part of the locking means moves clear of the actuation means.

19. A device as claimed in claim 1, wherein the actuation means is biased to a position in which it engages part of the locking means, when said locking means holds the striker in its first position.

20. A device as claimed in claim 19, wherein the actuation means are pivotally movable to disengage from the locking means, thereby allowing the locking means to be moved by the striker out of engagement therewith, as the striker moves, in use, to its second position under the force of the energy storage means.

21. A device as claimed in claim 20, wherein the actuation means is formed with means for attachment of a line to permit remote such pivotal operation of the actuation means and consequent movement of the striker to is second position.

22. A device as claimed in claim 1, wherein the locking means and the actuation means are respectively pivotally mounted in a housing at an open part of one side of a barrel in which the striker moves, in use.

23. A device as claimed in claim 1, comprising a mechanism for allowing or preventing operation of the actuation means.

24. A device as claimed in claim 23, wherein the mechanism is a switch operable between a first position where it prevents operation of the actuation means and a second position where it allows operation of the actuation means, and thus release of the locking means.

25. A device as claimed in claim 24, wherein in the first position of the switch, pivoting of the actuation means is prevented by engagement of a part thereof with a surface of the switch, whilst in the second position of the switch pivoting of the actuation means is permitted in that said part thereof is received in a recess in the surface of the switch.

26. A device as claimed in claim 24, wherein the switch is an angularly movable shaft.

27. A device as claimed in claim 24, wherein the switch is manually operable at one exterior side of a housing at an open part of one side of a barrel in which the striker moves, in use.

28. A device as claimed in claim 24, wherein the switch is releasably retained in each of its first and second positions.

29. A device as claimed in claim 24, wherein the striker can be moved to its first position when the switch is in either of its first and second positions.

30. A device as claimed in claim 1, comprising a mounting bracket between a barrel, in which the striker moves, in use, and said element for attaching the device to the glass to be broken.

31. A device as claimed in claim 30, wherein the mounting bracket has means for attachment of a line.

32. A device as claimed in claim 30, wherein the mounting bracket is attached to a suction pad for attaching the device to the glass to be broken.

33. A device as claimed in claim 1, which is attachable to the glass to be broken by a suction pad.

34. A device for breaking glass comprising a suction pad for attachment to the glass, in use, a striker rod having a tip for impacting said glass, energy storage means which are charged by movement of the striker rod to a first position thereof in which the tip is spaced from the glass and said charged energy storage means urge the striker to move to a second position where said tip impacts said glass, in use, a releasable locking pawl adapted to hold the striker rod in its first position when the locking pawl itself is so retained by a trigger, which trigger is remotely operable to release said retention of the locking pawl resulting in the movement of the striker rod to its second position.

35. A device for breaking a glass pane comprising means attachable to the glass pane, in use, a striker rod having a tip for impacting said glass pane, biasing means which are charged by the movement of the striker rod to a first position thereof in which the tip is spaced from the glass pane and said charged energy storage means urge the striker rod to move to a second position where said tip impacts said glass pane, in use, releasable locking means arranged to hold the striker rod in its first position when retained by actuation means, which are operable to release said retention of the locking means resulting in the movement of the striker rod to its second position, and a selector operable between a first position, where it prevents the actuation means being operated to release retention of the locking means, and a second position where it allows such operation of the actuation means.
